(19) United States
(12) Patent Application Publication
(10) Pub. No.: US 2006/0291739 A1
(43) Pub. Date: Dec. 28, 2006

(54) Apparatus, method and program for image processing

(75) Inventors: Yuanzhong Li, Kanagawa-ken (JP); Wataru Ito, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/474,294

(22) Filed: Jun. 26, 2006

(30) Foreign Application Priority Data
Jun. 24, 2005 (JP) 184593/2005

(51) Int. Cl. G06K 9/40

(52) U.S. Cl. 382/254

(57) ABSTRACT

Graininess reduction processing is carried out with accuracy by finding a degree of graininess in an image. For this purpose, a parameter acquisition unit obtains a weighting parameter for a principal component representing the degree of graininess in a face region found in the image by a face detection unit, by fitting to the face region a mathematical model generated by a method of AAM using a plurality of sample images representing human faces in different degrees of graininess. A parameter changing unit changes the parameter to have a desired value. A graininess reduction unit reduces graininess of the face region according to the parameter having been changed.

### BACKGROUND OF THE INVENTION

1. Field of the Invention

The present invention relates to an image processing apparatus and an image processing method for reducing graininess in an input image. The present invention also relates to a program for causing a computer to execute the image processing method.

2. Description of the Related Art

A system has been known wherein image data obtained by an imaging device such as a digital camera or a digital camcorder or image data obtained by reading an image recorded on a photographic film with a scanner are reproduced by a display device such as a printer or a monitor after various kinds of image processing is carried out thereon.

Image processing for improving sharpness while reducing graininess caused by grains of a photographic film has been proposed as image processing for image data obtained by reading an image recorded on the photographic film (see U.S. Pat. No. 5,739,922 and Japanese Unexamined Patent Publication No. 2001-218015). In a method described in U.S. Pat. No. 5,739,922, an image is decomposed into components of low, intermediate, and high frequencies, and the intermediate and high frequency components are multiplied by a gain for reducing the intermediate frequency component that has more grain components while emphasizing the high frequency components including more edges. A processed image is then obtained by compositing the processed frequency components with the remaining frequency component.

In the method described in Japanese Unexamined Patent Publication No. 2001-218015, a scene represented by an image is judged to be a portrait scene or a non-portrait scene based on a ratio of a face region of a person in the image to the entire image, and strength of graininess reduction processing and sharpness enhancement processing to be carried out on the image is determined according to a result of the judgment. The graininess reduction processing and the sharpness enhancement processing is carried out on the entire image or an image representing a local region therein.

However, although the methods described in U.S. Pat. No. 5,739,922 and Japanese Unexamined Patent Publication No. 2001-218015 can reduce graininess, graininess cannot be reduced appropriately according to a degree of graininess, since the degree of graininess is difficult to measure. In addition, in the method in Japanese Unexamined Patent Publication No. 2001-218015, a face region is extracted for calculating the ratio thereof to an entire image, which cannot be extracted with high accuracy due to an effect of shadow in the face, a signal discontinuity, and variance in skin color. As a result, graininess cannot be reduced properly.

### SUMMARY OF THE INVENTION

The present invention has been conceived based on consideration of the above circumstances. An object of the present invention is therefore to reduce graininess with accuracy by finding a degree of graininess.

A first image processing apparatus of the present invention comprises:

parameter acquisition means for obtaining a weighting parameter for a statistical characteristic quantity representing a degree of graininess in a predetermined structure in an input image by fitting a model representing the structure to the structure in the input image, the model having been obtained by carrying out predetermined statistical processing on a plurality of images representing the predetermined structure in different degrees of graininess, and the model representing the structure by one or more statistical characteristic quantities including the statistical characteristic quantity representing the degree of graininess and by weighting parameter or parameters for weighting the statistical characteristic quantity or quantities according to an individual characteristic of the structure;

parameter changing means for changing a value of the weighting parameter obtained by the parameter acquisition means to a desired value; and

graininess reduction means for reducing graininess of the structure in the input image according to the weighting parameter having been changed.

A second image processing apparatus of the present invention comprises:

parameter acquisition means for obtaining a weighting parameter for a statistical characteristic quantity representing a degree of graininess in a predetermined structure in an input image by fitting a model representing the structure to the structure in the input image, the model having been obtained by carrying out predetermined statistical processing on a plurality of images representing the predetermined structure in different degrees of graininess, and the model representing the structure by one or more statistical characteristic quantities including the statistical characteristic quantity representing the degree of graininess and by weighting parameter or parameters for weighting the statistical characteristic quantity or quantities according to an individual characteristic of the structure; and

graininess reduction means for reducing graininess in the input image according to a value of the weighting parameter having been obtained by the parameter acquisition means.

A third image processing apparatus of the present invention comprises:

reconstruction means for obtaining a reconstructed image of a predetermined structure in an input image having a grain component by reconstructing an image representing the structure after fitting a model representing the structure to the structure in the input image, the model having been obtained by carrying out predetermined statistical processing on a plurality of images representing the predetermined structure without a grain component, and the model representing the structure by one or more statistical characteristic quantities and by weighting parameter or parameters for weighting the statistical characteristic quantity or quantities according to an individual characteristic of the structure;

graininess degree acquisition means for obtaining a degree of graininess in the structure in the input image by calculating a difference value between values of pixels corresponding to each other in the predetermined structure in the reconstructed image and in the input image; and

graininess reduction means for reducing graininess in the input image according to the degree of graininess obtained by the graininess degree acquisition means.

A first image processing method of the present invention comprises the steps of:

obtaining a weighting parameter for a statistical characteristic quantity representing a degree of graininess in a predetermined structure in an input image by fitting a model representing the structure to the structure in the input image, the model having been obtained by carrying out predetermined statistical processing on a plurality of images representing the predetermined structure in different degrees of graininess, and the model representing the structure by one or more statistical characteristic quantities including the statistical characteristic quantity representing the degree of graininess and by weighting parameter or parameters for weighting the statistical characteristic quantity or quantities according to an individual characteristic of the structure; and

changing a value of the weighting parameter to a desired value; and

reducing graininess of the structure in the input image according to the weighting parameter having been changed.

A second image processing method of the present invention comprises the steps of:

obtaining a weighting parameter for a statistical characteristic quantity representing a degree of graininess in a predetermined structure in an input image by fitting a model representing the structure to the structure in the input image, the model having been obtained by carrying out predetermined statistical processing on a plurality of images representing the predetermined structure in different degrees of graininess, and the model representing the structure by one or more statistical characteristic quantities including the statistical characteristic quantity representing the degree of graininess and by weighting parameter or parameters for weighting the statistical characteristic quantity or quantities according to an individual characteristic of the structure; and

reducing graininess in the input image according to a value of the weighting parameter having been obtained.

A third image processing method of the present invention comprises the steps of:

obtaining a reconstructed image of a predetermined structure in an input image having a grain component by reconstructing an image representing the structure after fitting a model representing the structure to the structure in the input image, the model having been obtained by carrying out predetermined statistical processing on a plurality of images representing the predetermined structure without a grain component, and the model representing the structure by one or more statistical characteristic quantities and by weighting parameter or parameters for weighting the statistical characteristic quantity or quantities according to an individual characteristic of the structure;

obtaining a degree of graininess in the structure in the input image by calculating a difference value between values of pixels corresponding to each other in the predetermined structure in the reconstructed image and in the input image; and

reducing graininess in the input image according to the degree of graininess having been obtained.

Image processing programs of the present invention are programs for causing a computer to execute the first to third image processing methods of the present invention (that is, programs causing a computer to function as the means described above).

The image processing apparatuses, the image processing methods, and the image processing programs of the present invention are described below in detail.

As a method of generating the model representing the predetermined structure in the present invention, a method of AAM (Active Appearance Model) can be used. An AAM is one of approaches in interpretation of the content of an image by using a model. For example, in the case where a human face is a target of interpretation, a mathematical model of human face is generated by carrying out principal component analysis on face shapes in a plurality of images to be learned and on information of luminance after normalization of the shapes. A face in a new input image is then represented by principal components in the mathematical model and corresponding weighting parameters, for reconstructing a face image (T. F. Cootes et al., “Active Appearance Models”, Proc. European Conference on Computer Vision, vol. 2, pp. 484-498, Springer, 1998; hereinafter referred to as Reference 1).

Graininess refers to unnecessary information in an image, such as random noise, white noise, an artifact, and JPEG compression noise. Graininess is especially more conspicuous in the case where sensitivity is insufficient at the time of photography. In image data obtained by reading an image recorded on a photographic film, graininess in the film appears in the image.

It is preferable for the predetermined structure to be suitable for modeling. In other words, variations in shape and color of the predetermined structure in images thereof preferably fall within a predetermined range. Especially, it is preferable for the predetermined structure to generate the statistical characteristic quantity or quantities contributing more to the shape and color thereof through statistical processing thereon. Furthermore, it is preferable for the predetermined structure to be a main part of image. More specifically, the predetermined structure can be a human face.

The plurality of images representing the predetermined structure in different graininess may be images obtained by actually photographing the predetermined structure in different graininess. Alternatively, the images may be generated through simulation for different graininess, based on an image of the structure having been photographed in a specific degree of graininess.

The plurality of images representing the predetermined structure without a grain component may be images obtained by actually photographing the predetermined structure in such a manner that a grain component is not included therein. Alternatively, the images may be generated through simulation for not having a grain component, based on an image of the structure having been photographed.

It is preferable for the predetermined statistical processing to be dimension reduction processing that can represent the predetermined structure by the statistical characteristic quantity or quantities of fewer dimensions than the number of pixels representing the predetermined structure. More specifically, the predetermined statistical processing may be multivariate analysis such as principal component analysis. In the case where principal component analysis is carried out as the predetermined statistical processing, the statistical characteristic quantity or quantities refers/refer to a principal component/principal components obtained through the principal component analysis.

In the case where the predetermined statistical processing is principal component analysis, principal components of higher orders contribute more to the shape and color than principal components of lower orders.

In the first and second image processing methods and the first and second image processing apparatuses, at least information on the degree of graininess needs to be represented in the characteristic quantity or quantities.

The characteristic quantity representing the degree of graininess may be represented by a single characteristic quantity or by a plurality of characteristic quantities.

The (predetermined) structure in the input image may be detected automatically or manually. In addition, the present invention may further comprise the step (or means) for detecting the structure in the input image. Alternatively, the structure may have been detected in the input image in the present invention.

A plurality of models may be prepared for respective properties of the predetermined structure in the present invention. In this case, the steps (or means) may be added to the present invention for obtaining any one or more of the properties of the structure in the input image and for selecting one of the models according to the property having been obtained. The weighting parameter can be obtained by fitting the selected model to the structure in the input image.

The properties refer to gender, age, and race in the case where the predetermined structure is human face. The property may be information for identifying an individual. In this case, the models for the respective properties refer to models for respective individuals.

As a specific method of obtaining the property may be listed image recognition processing having been known (such as image recognition processing described in Japanese Unexamined Patent Publication No. 11(1999)-175724). Alternatively, the property may be inferred or obtained based on information such as GPS information accompanying the input image.

Fitting the model representing the structure to the structure in the input image refers to calculation for representing the structure in the input image by the model. More specifically, in the case where the method of ARM described above is used, fitting the model refers to finding values of the weighting parameters for the respective principal components in the mathematical model.

In the second image processing apparatus and in the second image processing method, reducing the graininess according to the weighting parameter having been obtained refers to changing a degree of reducing graininess according to magnitude of the value of the weighting parameter having been obtained. More specifically, graininess is reduced more if the weighting parameter represents that the degree of graininess is high while graininess is reduced less if otherwise.

According to the first image processing method, the first image processing apparatus, and the first image processing program of the present invention, the weighting parameter corresponding to the characteristic quantity representing the degree of graininess in the structure in the input image is obtained by fitting to the predetermined structure in the input image the model representing the structure by the characteristic quantity or quantities including the characteristic quantity representing the degree of graininess and the weighting parameter or parameters therefor. The value of the weighting parameter is changed to the desired value, and the predetermined structure can be reconstructed according to the weighting parameter having been changed. In this manner, the present invention pays attention to the characteristic quantity representing the degree of graininess, and the degree of graininess is adjusted by changing the weighting parameter corresponding to the characteristic quantity representing the degree of graininess in the structure in the input image. Therefore, graininess can be reduced appropriately according to the degree of graininess in the input image.

According to the second image processing method, the second image processing apparatus, and the second image processing program of the present invention, the weighting parameter corresponding to the characteristic quantity representing the degree of graininess in the structure in the input image is obtained by fitting to the predetermined structure in the input image the model representing the structure by the characteristic quantity or quantities including the characteristic quantity representing the degree of graininess and the weighting parameter or parameters therefor. Based on the value of the weighting parameter having been obtained, graininess of the input image can be reduced. In this manner, the present invention pays attention to the characteristic quantity representing the degree of graininess, and the degree of graininess is adjusted by changing the weighting parameter corresponding to the characteristic quantity representing the degree of graininess in the structure in the input image. Therefore, graininess can be reduced appropriately according to the degree of graininess in the input image.

According to the third image processing method, the third image processing apparatus, and the third image processing program of the present invention, the reconstructed image is generated through reconstruction of the image representing the structure after fitting to the predetermined structure in the input image including a grain component the model representing the structure by the characteristic quantity or quantities obtained by the predetermined statistical processing on the images not having a grain component and by the weighting parameter or parameters for weighting the characteristic quantity or quantities according to an individual characteristic of the structure. In the reconstructed image, the grain component in the structure has been removed. The degree of graininess in the structure in the input image is obtained by calculating the difference between the values of pixels corresponding to each other in the structure in the input image and in the reconstructed image, and graininess in the input image is reduced according to the degree of graininess. Therefore, the degree of graininess can be obtained accurately in the input image, and graininess can be reduced appropriately according to the degree of graininess in the input image.

In the case where the predetermined structure is human face, a face is often a main part in an image. Therefore, graininess reduction optimized for the main part can be carried out.

In the case where the step (or the means) for detecting the structure in the input image is added, the structure can be detected automatically. Therefore, the image processing apparatuses become easier to operate.

In the case where the plurality of models are prepared for the respective properties of the predetermined structure in the present invention while the steps (or the means) are added for obtaining the property of the structure in the input image and for selecting one of the models in accordance with the property having been obtained, if the weighting parameter is obtained by fitting the selected model to the structure in the input image, the structure in the input image can be fit to the model that is more suitable. Therefore, processing accuracy is improved.

### BRIEF DESCRIPTION OF THE DRAWINGS

FIG. 1 shows hardware configuration of a digital photograph printer as an embodiment of the present invention;

FIG. 2 is a block diagram showing functions and a flow of processing in the digital photograph printer in the embodiment and in a digital camera in another embodiment of the present invention;

FIGS. 3A and 3B show examples of screens displayed on a display of the digital photograph printer and the digital camera in the embodiments;

FIG. 4 is a block diagram showing first graininess reduction processing in the embodiments of the present invention;

FIG. 5 is a flow chart showing a procedure for generating a mathematical model of face in the present invention;

FIG. 6 shows an example of how feature points are set in a face;

FIG. 7 shows how a face shape changes with change in values of weighting coefficients for eigenvectors of principal components obtained through principal component analysis on the face shape;

FIG. 8 shows luminance in mean face shapes converted from face shapes in sample images;

FIG. 9 shows how pixel values in a face change with change in values of weighting coefficients for eigenvectors of principal components obtained by principal component analysis on the pixel values in the face;

FIG. 10 is a block diagram showing second graininess reduction processing in the embodiments of the present invention;

FIG. 11 shows a structure of a reference table T1 and an example of values therein;

FIG. 12 is a block diagram showing third graininess reduction processing in the embodiments of the present invention;

FIGS. 13A to 13E show how an image changes in the third graininess reduction processing;

FIG. 14 shows a structure of a reference table T2 and an example of values therein;

FIG. 15 is a block diagram showing an advanced aspect of the graininess reduction processing of the present invention; and

FIG. 16 shows the configuration of the digital camera in the embodiment of the present invention.

### DESCRIPTION OF THE PREFERRED EMBODIMENTS

Hereinafter, embodiments of the present invention will be described with reference to the accompanying drawings.

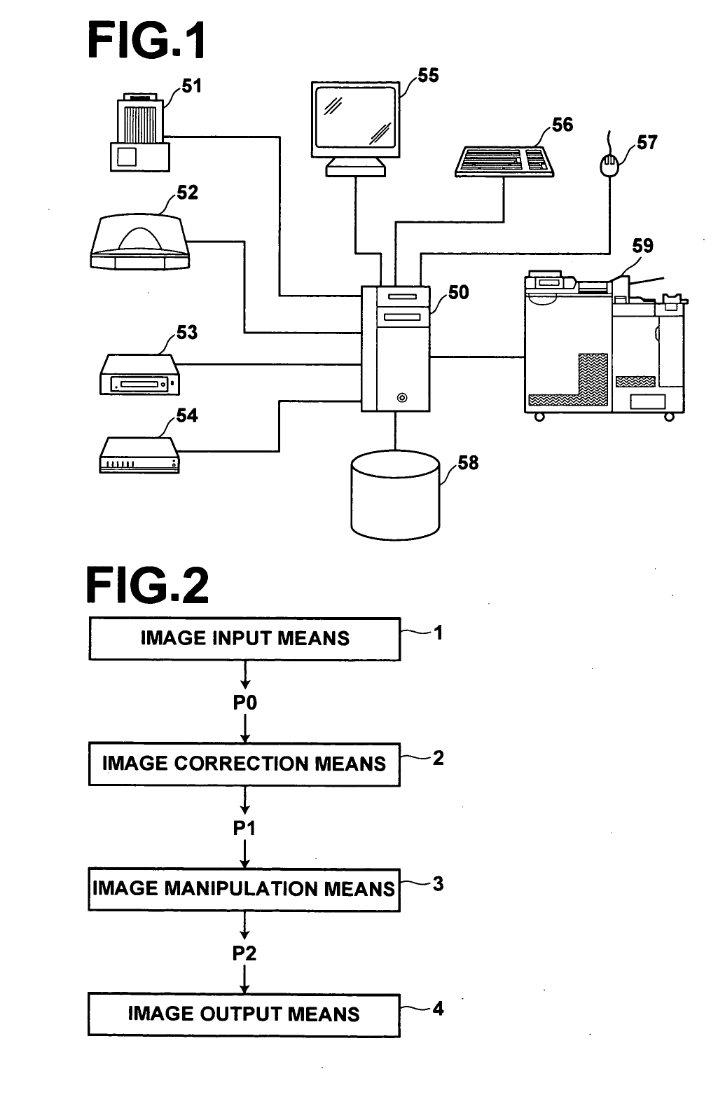

FIG. 1 shows hardware configuration of a digital photograph printer as an embodiment of the present invention. As shown in FIG. 1, the digital photograph printer comprises a film scanner 51, a flat head scanner 52, a media drive 53, a network adopter 54, a display 55, a keyboard 56, a mouse 57, a hard disc 58, and a photographic print output machine 59, all of which are connected to an arithmetic and control unit 50.

In cooperation with a CPU, a main storage, and various input/output interfaces, the arithmetic and control unit 50 controls a processing flow regarding an image, such as input, correction, manipulation, and output thereof, by executing a program installed from a recording medium such as a CD-ROM. In addition, the arithmetic and control unit 50 carries out image processing calculation for image correction and manipulation. Graininess reduction processing of the present invention is also carried out by the arithmetic and control unit 50.

The film scanner 51 photoelectrically reads an APS negative film or a 135-mm negative film developed by a film developer (not shown) for obtaining digital image data P0 representing a photograph image recorded on the negative film.

The flat head scanner 52 photoelectrically reads a photograph image represented in the form of hard copy such as an L-size print, for obtaining digital image data P0.

The media drive 53 obtains digital image data P0 representing a photograph image recorded in a recording medium such as a memory card, a CD, and a DVD. The media drive 53 can also write image data P2 to be output therein. The memory card stores image data representing an image photographed by a digital camera, for example. The CD or the DVD stores data of an image read by the film scanner regarding a printing order placed before, for example.

The network adopter 54 obtains image data P0 from an order reception machine (not shown) in a network photograph service system having been known. The image data P0 are image data used for a photograph print order placed by a user, and sent from a personal computer of the user via the Internet or via a photograph order reception machine installed in a photo laboratory.

The display 55 displays an operation screen for input, correction, manipulation, and output of an image by the digital photograph printer. A menu for selecting the content of operation and an image to be processed are also displayed thereon, for example. The keyboard 56 and the mouse 57 are used for inputting an instruction.

The hard disc 58 stores a program for controlling the digital photograph printer. In the hard disc 58 are also stored temporarily the image data P0 obtained by the film scanner 51, the flat head scanner 52, the media drive 53, and the network adopter 54, in addition to image data P1 having been subjected to image correction (hereinafter referred to as the corrected image data P1) and the image data P2 having been subjected to image manipulation (the image data to be output).

The photographic print output machine 59 carries out laser scanning exposure of a photographic printing paper, image development thereon, and drying thereof, based on the image data P2 representing the image to be output. The photographic print output machine 59 also prints printing information on the backside of the paper, cuts the paper for each print, and sorts the paper for each order. The manner of printing may be a laser exposure thermal development dye transfer method.

FIG. 2 is a block diagram showing functions of the digital photograph printer and the flow of processing carried out therein. As shown in FIG. 2, the digital photograph printer comprises image input means 1, image correction means 2, image manipulation means 3, and image output means 4 in terms of the functions. The image input means 1 inputs the image data P0 of an image to be printed. The image correction means 2 uses the image data P0 as input, and carries out automatic image quality correction of the image represented by the image data P0 (hereinafter, image data and an image represented by the image data are represented by the same reference code) through image processing according to a predetermined image processing condition. The image manipulation means 3 uses the corrected image data P1 having been subjected to the automatic correction as input, and carries out image processing according to an instruction from an operator. The image output means 4 uses the processed image data P2 as input, and outputs a photographic print or outputs the processed image data P2 in a recording medium.

The image correction means 2 carries out processing such as gradation correction, density correction, color correction, sharpness correction, white balance adjustment, and noise reduction and removal, in addition to the graininess reduction processing of the present invention. The image manipulation means 3 carries out manual correction on a result of the processing carried out by the image correction means 2. In addition, the image manipulation means 3 carries out image manipulation such as trimming, scaling, change to sepia image, change to monochrome image, and compositing with an ornamental frame.

Operation of the digital photograph printer and the flow of the processing therein will be described next.

The image input means 1 firstly inputs the image data P0. In the case where an image recorded on a developed film is printed, the operator sets the film on the film scanner 51. In the case where image data stored in a recording medium such as a memory card are printed, the operator sets the recording medium in the media drive 53. A screen for selecting a source of input of the image data is displayed on the display 55, and the operator carries out the selection by using the keyboard 56 or the mouse 57. In the case where film has been selected as the source of input, the film scanner 51 photoelectrically reads the film set thereon, and carries out digital conversion. The image data P0 generated in this manner are then sent to the arithmetic and control unit 50. In the case where hard copy such as a photographic print has been selected, the flat head scanner 52 photoelectrically reads the hard copy set thereon, and carries out digital conversion. The image data P0 generated in this manner are then sent to the arithmetic and control unit 50. In the case where recording medium such as a memory card has been selected, the arithmetic and control unit 50 reads the image data P0 stored in the recording medium such as a memory card set in the media drive 53. In the case where an order has been placed in a network photograph service system or by a photograph order reception machine in a store, the arithmetic and control unit 50 receives the image data P0 via the network adopter 54. The image data P0 obtained in this manner are temporarily stored in the hard disc 58.

The image correction means 2 then carries out the automatic image quality correction on the image represented by the image data P0. More specifically, publicly known processing such as gradation correction, density correction, color correction, sharpness correction, white balance adjustment, and noise reduction and removal is carried out based on a setup condition set on the printer in advance, according to an image processing program executed by the arithmetic and control unit 50. The graininess reduction processing of the present invention is also carried out, and the corrected image data P1 are output to be stored in a memory of the arithmetic and control unit 50. Alternatively, the corrected image data P1 may be stored temporarily in the hard disc 58.

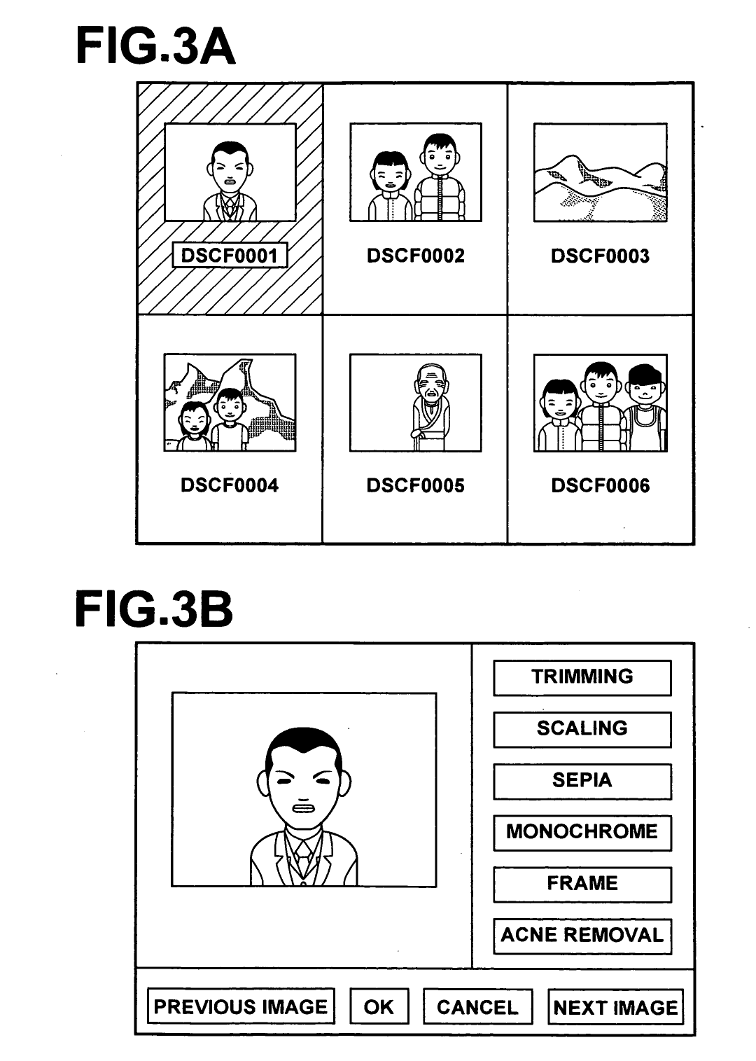

The image manipulation means 3 thereafter generates a thumbnail image of the corrected image P1, and causes the display 55 to display the thumbnail image. FIG. 3A shows an example of a screen displayed on the display 55. The operator confirms displayed thumbnail images, and selects any one of the thumbnail images that needs manual image-quality correction or order processing for image manipulation while using the keyboard 56 or the mouse 57. In FIG. 3A, the image in the upper left corner (DSCF0001) is selected. As shown in FIG. 3B as an example, the selected thumbnail image is enlarged and displayed on the display 55, and buttons are displayed for selecting the content of manual correction and manipulation on the image. The operator selects a desired one of the buttons by using the keyboard 56 or the mouse 57, and carries out detailed setting of the selected content if necessary. The image manipulation means 3 carries out the image processing according to the selected content, and outputs the processed image data P2. The image data P2 are stored in the memory of the arithmetic and control unit 50 or stored temporarily in the hard disc 58. The program executed by the arithmetic and control unit 50 controls image display on the display 55, reception of input from the keyboard 56 or the mouse 57, and image processing such as manual correction and manipulation carried out by the image manipulation means 3.

The image output means 4 finally outputs the image P2. The arithmetic and control unit 50 causes the display 55 to display a screen for image destination selection, and the operator selects a desired one of destinations by using the keyboard 56 or the mouse 57. The arithmetic and control unit 50 sends the image data P2 to the selected destination. In the case where a photographic print is generated, the image data P2 are sent to the photographic print output machine 59 by which the image data P2 are output as a photographic print. In the case where the image data P2 are recorded in a recording medium such as a CD, the image data P2 are written in the CD or the like set in the media drive 53.

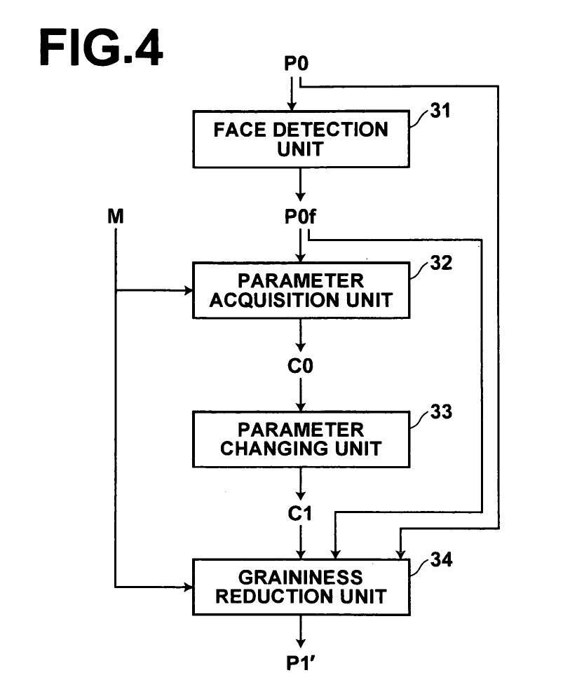

The graininess reduction processing of the present invention carried out by the image correction means 2 will be described below in detail. FIG. 4 is a block diagram showing details of first graininess reduction processing. As shown in FIG. 4, the graininess reduction processing is carried out by a face detection unit 31, a parameter acquisition unit 32, a parameter changing unit 33, and a graininess reduction unit 34. The face detection unit 31 detects a face region P0f in the image P0. The parameter acquisition unit 32 obtains a weighting parameter C0 for a principal component representing a degree of graininess in the face region P0f by fitting to the face region P0f a mathematical model M generated by a method of AAM (see Reference 1 described above) based on sample images representing human faces in different degrees of graininess. The parameter changing unit 33 changes the weighting parameter C0 to a weighting parameter C1 having a desired value. The graininess reduction unit 34 generates an image P1′ wherein graininess of the face region P0f has been reduced, by applying the parameters C1 to the mathematical model M. The image P1′ is an image having been subjected only to the graininess reduction processing, and the image P1 is an image having been subjected to all the processing described above, such as gradation correction and white balance adjustment. The processing described above is carried out according to the control program stored in the internal memory 79.

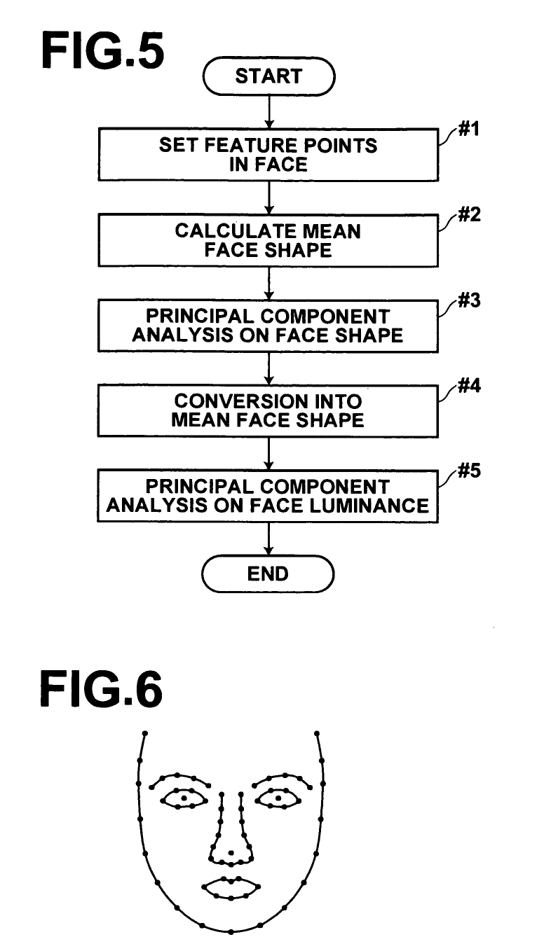

The mathematical model M is generated according to a flow chart shown in FIG. 5, and stored in advance in the internal memory 79 together with the programs described above. Hereinafter, how the mathematical model M is generated is described.

For each of the sample images representing human faces in different degrees of graininess, feature points are set as shown in FIG. 6 for representing face shape (Step #1). In this case, the number of the feature points is 122. However, only 60 points are shown in FIG. 6 for simplification. Which part of face is represented by which of the feature points is predetermined, such as the left corner of the left eye represented by the first feature point and the center between the eyebrows represented by the 38^{th} feature point. Each of the feature points may be set manually or automatically according to recognition processing. Alternatively, the feature points may be set automatically and later corrected manually upon necessity.

Based on the feature points set in each of the sample images, mean face shape is calculated (Step #2). More specifically, mean values of coordinates of the feature points representing the same part are found among the sample images.

Principal component analysis is then carried out based on the coordinates of the mean face shape and the feature points representing the face shape in each of the sample images (Step #3). As a result, any face shape can be approximated by Equation (1) below:
S=S₀+Σᵢ₌ₗⁿpᵢbᵢ (1)

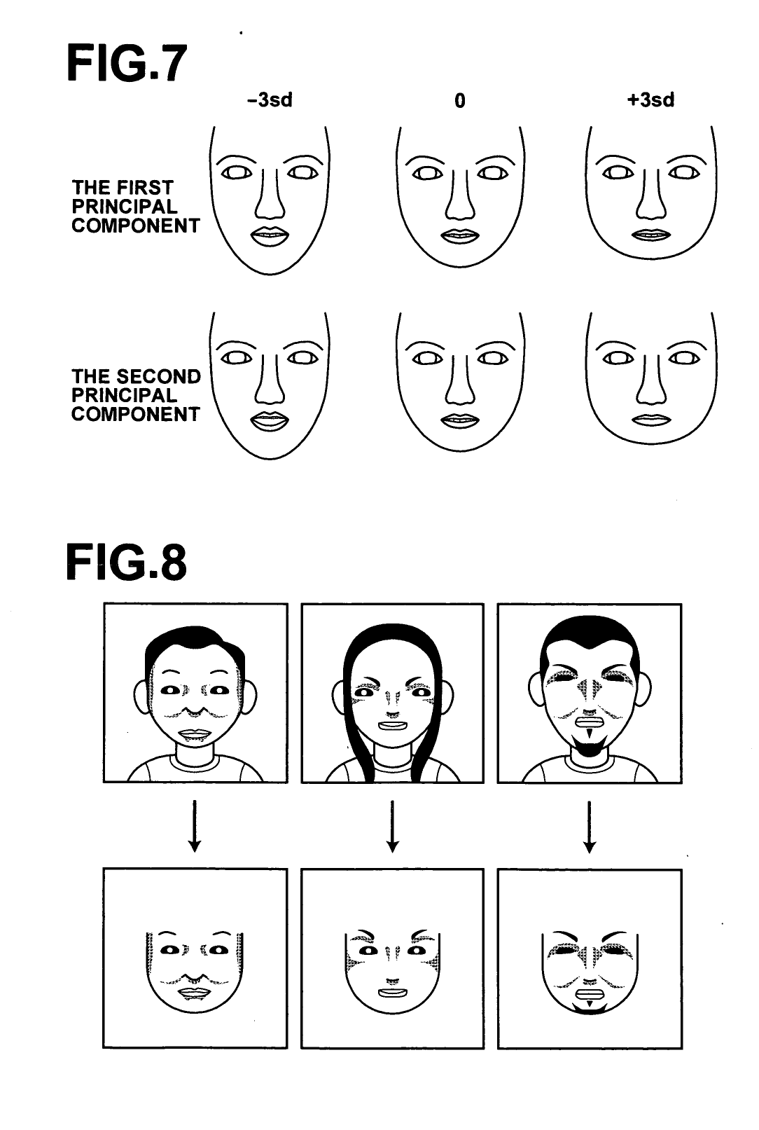

S and S0 are shape vectors represented respectively by simply listing the coordinates of the feature points (x1, y1, . . . , x122, y122) in the face shape and in the mean face shape, while pi and bi are an eigenvector representing the i^{th} principal component for the face shape obtained by the principal component analysis and a weight coefficient therefor, respectively. FIG. 7 shows how face shape changes with change in values of the weight coefficients b1 and b2 for the eigenvectors p1 and p2 as the highest and second-highest order principal components obtained by the principal component analysis. The change ranges from −3 sd to +3 sd where sd refers to standard deviation of each of the weighting coefficients b1 and b2 in the case where the face shape in each of the sample images is represented by Equation (1). The face shape in the middle of 3 faces for each of the components represents the face shape in the case where the values of the weighting coefficients are the mean values. In this example, a component contributing to face outline has been extracted as the first principal component through the principal component analysis. By changing the weight coefficient b1, the face shape changes from an elongated shape (corresponding to −3 sd) to a round shape (corresponding to +3 sd). Likewise, a component contributing to how much the mouth is open and to length of chin has been extracted as the second principal component. By changing the weight coefficient b2, the face changes from a state of open mouth and long chin (corresponding to −3 sd) to a state of closed mouth and short chin (corresponding to +3 sd). The smaller the value of i, the better the component explains the shape. In other words, the i^{th} component contributes more to the face shape as the value of i becomes smaller.

Each of the sample images is then subjected to conversion (warping) into the mean face shape obtained at Step #2 (Step #4). More specifically, shift values are found between each of the sample images and the mean face shape, for the respective feature points. In order to warp pixels in each of the sample images to the mean face shape, shift values to the mean face shape are calculated for the respective pixels in each of the sample images according to 2-dimensional 5-degree polynomials (2) to (5) using the shift values having been found:

$$\begin{matrix}{x}^{′} = x + Δ x & ( 2 ) \\ {y}^{′} = y + Δ y & ( 3 ) \\ Δ x = {\sum }_{i = 0}^{n} {\sum }_{j = 0}^{n - i} {a}_{ij} \cdot {x}^{i} \cdot {y}^{j} & ( 4 ) \\ Δ y = {\sum }_{i = 0}^{n} {\sum }_{j = 0}^{n - i} {b}_{ij} \cdot {x}^{i} \cdot {y}^{j} & ( 5 )\end{matrix}$$

In Equations (2) to (5) above, x and y denote the coordinates of each of the feature points in each of the sample images while x′ and y′ are coordinates in the mean face shape to which x and y are warped. The shift values to the mean shape are represented by Δx and Δy with n being the number of dimensions while aij and bij are coefficients. The coefficients for polynomial approximation can be found by using a least square method. At this time, for a pixel to be moved to a position represented by non-integer values (that is, values including decimals), pixel values therefor are found through linear approximation using 4 surrounding points. More specifically, for 4 pixels surrounding coordinates of the non-integer values generated by warping, the pixel values for each of the 4 pixels are determined in proportion to a distance thereto from the coordinates generated by warping. FIG. 8 shows how the face shape of each of 3 sample images is changed to the mean face shape.

Thereafter, principal component analysis is carried out, using as variables the values of RGB colors of each of the pixels in each of the sample images after the change to the mean face shape (Step #5). As a result, the pixel values of RGB colors in the mean face shape converted from any arbitrary face image can be approximated by Equation (6) below:

$$A = {A}_{0} + {\sum }_{i = 1}^{m} {q}_{i} {λ}_{i} \qquad ( 6 )$$

In Equation (6), A denotes a vector (r1, g1, b1, r2, g2, b2, . . . , rm, gm, bm) represented by listing the pixel values of RGB colors at each of the pixels in the mean face shape (where r, g, and b represent the pixel values of RGB colors while 1 to m refer to subscripts for identifying the respective pixels with m being the total number of pixels in the mean face shape). The vector components are not necessarily listed in this order in the example described above. For example, the order may be (r1, r2, . . . , rm, g1, g2, . . . , gm, b1, b2, . . . , bm). A0 is a mean vector represented by listing mean values of the RGB values at each of the pixels in the mean face shape while qi and λi refer to an eigenvector representing the i^{th} principal component for the RGB pixel values in the face obtained by the principal component analysis and a weight coefficient therefor, respectively. The smaller the value of i is, the better the component explains the RGB pixel values. In other words, the component contributes more to the RGB pixel values as the value of i becomes smaller.

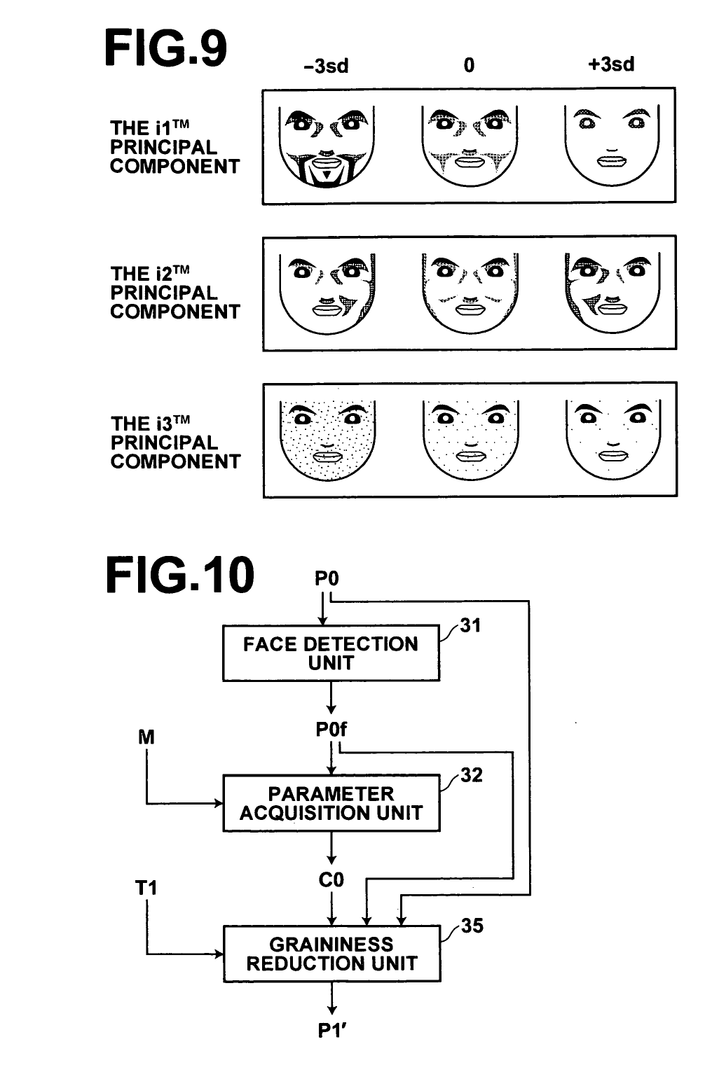

FIG. 9 shows how faces change with change in values of the weight coefficients λi1, λi2, and λi3 for the eigenvectors qi1, qi2, and qi3 representing the i1^{th}, i2^{th}, and i3^{th} principal components obtained through the principal component analysis. The change in the weight coefficients ranges from −3 sd to +3 sd where sd refers to standard deviation of each of the values of the weight coefficients λi1, λi2, and λi3 in the case where the pixel values in each of the sample face images are represented by Equation (6) above. For each of the principal components, the face in the middle of the 3 images corresponds to the case where the weight coefficients λi1, λi2, and λi3 are the mean values. In the examples shown in FIG. 8, a component contributing to presence or absence of beard has been extracted as the i1^{th} principal component through the principal component analysis. By changing the weight coefficient λi1, the face changes from the face with dense beard (corresponding to −3 sd) to the face with no beard (corresponding to +3 sd). Likewise, a component contributing to how a shadow appears on the face has been extracted as the i2^{th} principal component through the principal component analysis. By changing the weight coefficient λi2, the face changes from the face with a shadow on the right side (corresponding to −3 sd) to the face with a shadow on the left side (corresponding to +3 sd). Furthermore, a component contributing to graininess has been extracted as the i3^{th} principal component through the principal component analysis. By changing the weight coefficient λi3, the face changes from the face with grainy appearance (corresponding to −3 sd) to the face with few grainy appearance (corresponding to +3 sd). How each of the principal components contributes to what factor is determined through interpretation.

In this embodiment, the plurality of human face images in different degrees of graininess have been used as the sample images. Therefore, components contributing to difference in graininess are extracted as the principal components of higher order corresponding to smaller values of i including the first principal component. For example, in the case where a component contributing to difference in graininess has been extracted as the first principal component, graininess changes in the image P0 as shown in FIG. 9 with change in the value of the weight coefficient λ1 corresponding to the eigenvector q1 of the first principal component.

The principal components contributing the degree of graininess are not necessarily extracted as the higher-order principal components corresponding to smaller values of i. Furthermore, the difference in the degree of graininess is not necessarily represented by only one principal component, and a plurality of principal components may explain the difference in some cases.

Through the processing from Step #1 to #5 described above, the mathematical model M can be generated. In other words, the mathematical model M is represented by the eigenvectors pi representing the face shape and the eigenvectors qi representing the pixel values in the mean face shape, and the number of the eigenvectors is far smaller for pi and for qi than the number of pixels forming the face image. In other words, the mathematical model M has been compressed in terms of dimension. In the example described in Reference 1, 122 feature points are set for a face image of approximately 10,000 pixels, and a mathematical model of face image represented by 23 eigenvectors for face shape and 114 eigenvectors for face pixel values has been generated through the processing described above. By changing the weight coefficients for the respective eigenvectors, more than 90% of variations in face shape and pixel values can be expressed according to Reference 1.

The first graininess reduction processing according to the method of AAM using the mathematical model M is described below, with reference to FIG. 4.

The face detection unit 31 firstly reads the image data P0, and detects the face region P0f in the image P0. More specifically, the face region P0f can be detected through various known methods such as a method using a correlation score between an eigen-face representation and an image as has been described in PCT Japanese Publication No. 2004-527863 (hereinafter referred to as Reference 2). Alternatively, the face region P0f can be detected by using a knowledge base, characteristics extraction, skin-color detection, template matching, graph matching, and a statistical method (such as a method using a neural network, SVM, or HMM), for example. Furthermore, the face region P0f may be specified manually with use of the mouse 57 and the keyboard 56 when the image P0 is displayed on the display unit 55. Alternatively, a result of automatic detection of the face region may be corrected manually.

Thereafter, the parameter acquisition unit 32 carries out processing for fitting the mathematical model M to the face region P0f. More specifically, an image is reconstructed according to Equations (1) and (6) described above while sequentially changing the values of the weight coefficients bi and λi for the eigenvectors pi and qi corresponding to the principal components in order of higher order in Equations (1) and (6). The values of the weight coefficients bi and λi causing a difference between the reconstructed image and the face region P0f to become minimal are then found (see Reference 2 for details). Among the weight coefficients λi, the weight coefficient λi representing the degree of graininess is the parameter C0. In the case where the number of the principal components contributing to the difference in graininess is larger than 1, the parameter C0 comprises the plurality of weight coefficients λi therefor. The values of the weight coefficients bi and λi are allowed to range only from −3 sd to +3 sd where sd refers to the standard deviation in each of distributions of bi and λi when the sample images used at the time of generation of the model are represented by Equations (1) and (6). In the case where the values are smaller than −3 sd, the values of the weight coefficients are set to be −3 sd. Likewise, if the values are larger than +3 sd, the values are set to be +3 sd. In this manner, erroneous application of the model can be avoided.

The parameter changing unit 33 changes the value of the parameter C0 to the value of the parameter C1 representing a preferable degree of graininess. If graininess is completely removed from the image P0, the image looks unnatural. Therefore, a value enabling reduction of graininess to a degree that is not unnatural is used as the value for the parameter C1. The value of the parameter C1 is determined based on experiment and experience.

In the case where the number of the principal components contributing the difference in graininess is larger than 1, the parameter C0 may be determined as a linear combination of the weight coefficients as shown by Equation (7) below. In Equation (7), a i is a coefficient representing a rate of contribution of the principal component corresponding to the weight coefficient λi to the degree of graininess. In this case, the parameter C1 is a linear combination of the weight coefficients corresponding to the preferable degree of graininess.

$$C 0 = {\sum }_{i = 1}^{J} {α}_{i} {λ}_{i} \qquad ( 7 )$$

The graininess reduction unit 34 carries out processing for reducing graininess of the face region P0f according to the parameter C1, and generates the image P1′ whose graininess has been reduced. More specifically, the graininess-reduced the image P1′ is generated by reconstructing the image of the face region P0f according to the parameter C1.

As has been described above, according to the first graininess reduction processing in the embodiment of the present invention, the parameter acquisition unit 32 obtains the weighting parameter C0 corresponding to the principal component representing the degree of graininess in the face region P0f detected in the image P0 by the face detection unit 31, by fitting to the face region P0f the mathematical model M generated by the method of AAM using the sample images representing human faces having different degrees of graininess, and the parameter changing unit 33 changes the parameter C0 to the parameter C1 representing the preferable degree of graininess. Based on the parameter C1, graininess in the face region P0f is reduced. Therefore, graininess can be reduced appropriately according to the degree of graininess of the image P0.

Second graininess reduction processing in the embodiment of the present invention is described next. FIG. 10 is a block diagram showing the second graininess reduction processing in the embodiment of the present invention. In FIG. 10, the same elements as in FIG. 4 have the same reference codes, and detailed description thereof is omitted. The second graininess reduction processing is different from the first graininess reduction processing in that a graininess reduction unit 35 is used instead of the parameter changing unit 33 and the graininess reduction unit 34 in the first graininess reduction processing, for generating the image P1′ by reducing graininess of the image P0 according to the value of the parameter C0. Hereinafter, processing carried out by the graininess reduction unit 35 is described.

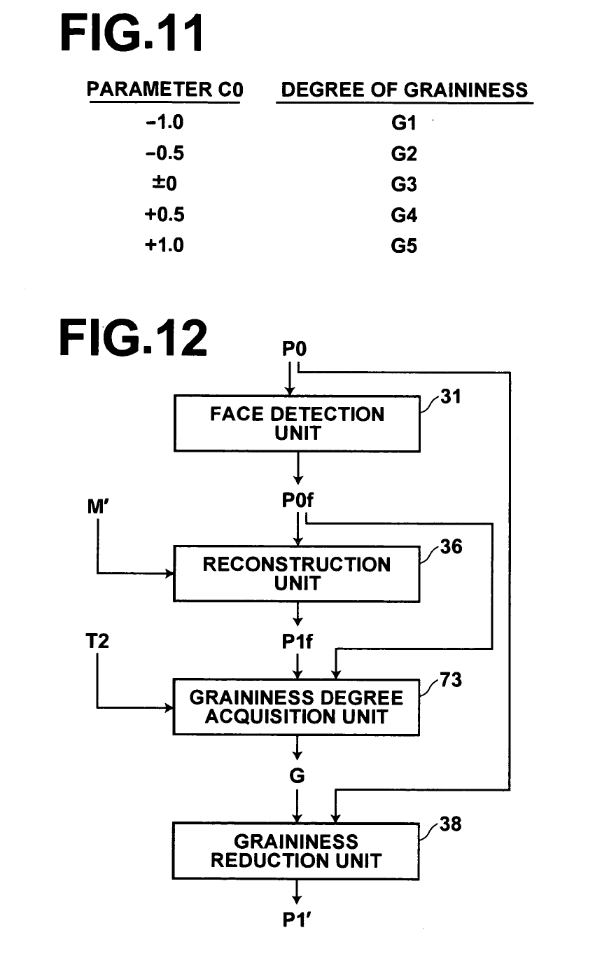

The graininess reduction unit 35 refers to a reference table T1 based on the parameter C0 having been found, and judges the degree of graininess in the face region P0f. FIG. 11 shows a structure of the reference table T1 and an example of values therein. The parameter C0 comprises only one weight coefficient. In the first graininess reduction processing described above, graininess changes with change in the value of the parameter C0. Therefore, the degree of graininess in the face region P0f in the image P0 can be understood by looking at the value of the parameter C0. The reference table T1 shows a relationship between the value of C0 and the degree of graininess found empirically and statistically in advance. In the reference table T1, the smaller the value of C0 is, the higher the degree of graininess is. In other words, G1>G2>G3>G4>G5. A degree G of graininess has a value enabling relative recognition of graininess, and set to be (G1, G2, G3, G4, G5)=(1.0, 0.8, 0.6, 0.4, 0.2), for example.

The graininess reduction unit 35 carries out processing for reducing graininess of the image P0 according to the degree G of graininess having been found, and generates the image P1′ wherein graininess has been reduced. As the processing for reducing graininess, the methods described in U.S. Pat. No. 5,739,922 and Japanese Unexamined Patent Publication No. 2001-218015 can be used, for example. More specifically, graininess is reduced in such a manner that an intermediate frequency component is reduced more as the degree G of graininess becomes larger. The processing for reducing graininess may be carried out only on the face region P0f, instead of the entire image P0.

According to the second graininess reduction processing in the embodiment of the present invention, the parameter acquisition unit 32 obtains the weighting parameter C0 corresponding to the principal component representing the degree of graininess in the face region P0f detected in the image P0 by the face detection unit 31, by fitting to the face region P0f the mathematical model M generated by the method of AAM using the sample images representing human faces having different degrees of graininess, and the graininess reduction unit 35 reduces graininess in the image P0 according to the weighting parameter C0. Therefore, graininess can be reduced appropriately according to the degree of graininess of the image P0.

Third graininess reduction processing in the embodiment of the present invention is described next. FIG. 12 is a block diagram showing the third graininess reduction processing in the embodiment. In FIG. 12, the same elements as in FIG. 4 have the same reference codes, and detailed description thereof is omitted. The third graininess reduction processing is different from the first graininess reduction processing in that a reconstruction unit 36, a graininess degree acquisition unit 37, and a graininess reduction unit 38 are used therefor, instead of the parameter acquisition unit 32, the parameter changing unit 33, and the graininess reduction unit 34 in the first graininess reduction processing. Hereinafter, processing carried out by the reconstruction unit 36, the graininess degree acquisition unit 37, and the graininess reduction unit 38 is described.

In the first and second graininess reduction processing is used the mathematical model M generated by the method of AAM (see Reference 1 above) using the sample images representing human faces in different degrees of graininess. In the third graininess reduction processing is however used a mathematical model M′ generated by a method of AAM using sample images representing human faces without a grain component.

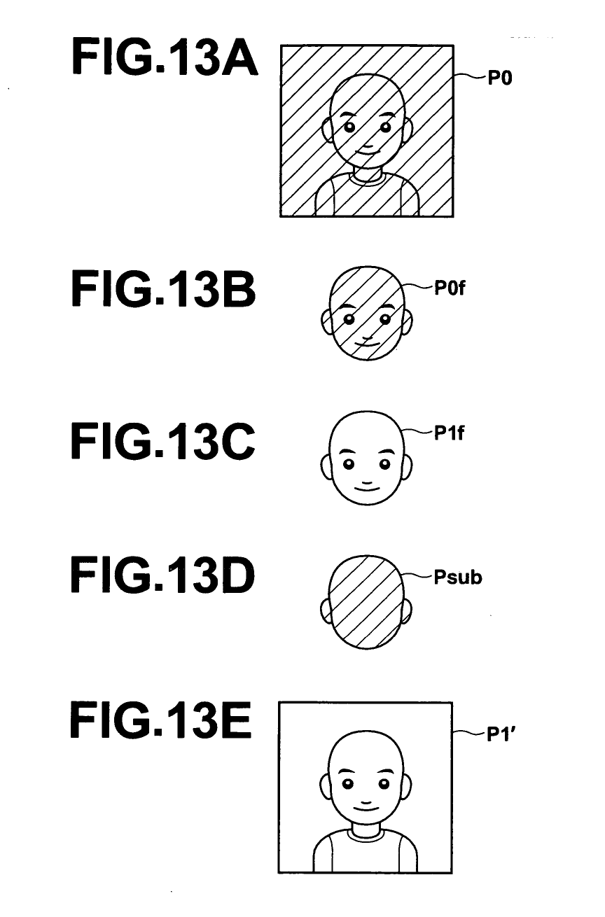

FIGS. 13A to 13E show how an image changes in the third graininess reduction processing. FIG. 13A shows an image P0 while FIG. 13B shows a face region P0f. The image P0 and the face region P0f have a grain component shown by diagonal lines.

The reconstruction unit 36 fits the mathematical model M′ to the face region P0f, and reconstructs the face region P0f. More specifically, the reconstruction unit 36 reconstructs the image based on Equation (1) and (6) above while changing the values of the weight coefficients bi and λi for the eigenvectors pi and qi corresponding to the principal components in order of higher order in Equations (1) and (6). The reconstruction unit 36 then finds the values of the weight coefficients bi and λi that cause the difference between the reconstructed image and the face region P0f to become minimal (see Reference 2 for details). It is preferable for the values of the weight coefficients bi and λi to range only from −3 sd to +3 sd where sd refers to the standard deviation in each of the distributions of bi and λi when the sample images used at the time of generation of the model are represented by Equations (1) and (6). In the case where the values do not fall within the range, it is preferable for the weight coefficients to take the mean values in the distributions. In this manner, erroneous application of the model can be avoided.

The reconstruction unit 36 generates a reconstructed image P1f by using the values of the weight coefficients bi and λi having been found. FIG. 13C shows the reconstructed image P1f. As shown in FIG. 13C, the reconstructed image P1f does not have the grain component, since the mathematical model M′ has been generated from the sample images without a grain component.

The graininess degree acquisition unit 37 then calculates difference values Psub between values of pixels corresponding to each other in the face region P0f and the reconstructed image P1f. More specifically, the difference values Psub are calculated by subtraction of the values of the pixels in the reconstructed image P1f from the values of the corresponding pixels in the face region P0f. FIG. 13D shows the difference values Psub. As shown in FIG. 13D, the difference values Psub represent the grain component in the region corresponding to the face region P0f.

The graininess degree acquisition unit 37 finds a representative value Psub′ of the difference values Psub in the face region P0f. As the representative value Psub′ can be used a mean value or a median of the difference values Psub in the face region P0f. The graininess degree acquisition unit 37 obtains the degree G of graininess in the face region P0f with reference to a reference table T2.

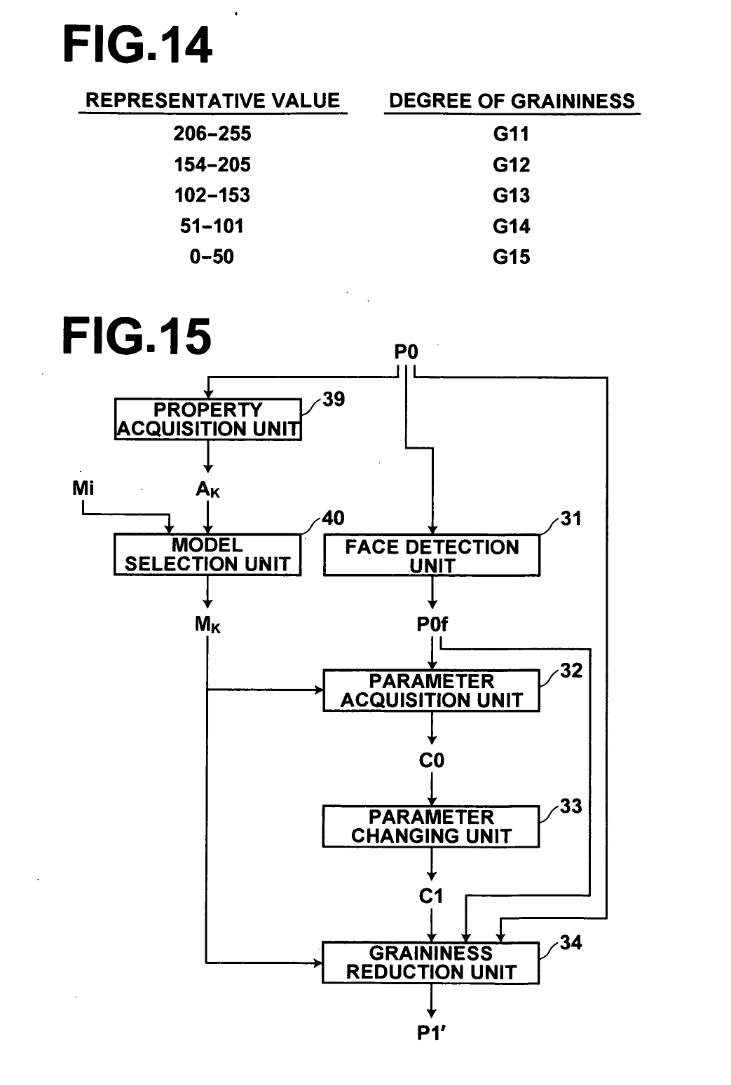

FIG. 14 shows a structure of the reference table T2 and an example of values therein. The representative value Psub′ takes an 8-bit value. Since the reconstructed image P1f does not have any grain component, the grain component exists more in the face region P0f as the value of the representative value Psub′ becomes larger. The reference table T2 shows a relationship between the representative value Psub′ and the degree of graininess found empirically and statistically in advance. In the reference table T2, the larger the value of the representative value Psub′ is, the higher the degree of graininess is. In other words, G11>G12>G13>G14>G15. The degree G of graininess has a value enabling relative recognition of graininess, and set to be (G11, G12, G13, G14, G15)=(1.0, 0.8, 0.6, 0.4, 0.2), for example.

The graininess reduction unit 38 carries out processing for reducing graininess of the image P0 according to the degree G of graininess having been found, and generates the image P1′ wherein graininess has been reduced. FIG. 13E shows the image P1′. As shown in FIG. 13E, the grain component in the image P0 has been removed in the image P1′. As the processing for reducing graininess, the methods described in U.S. Pat. No. 5,739,922 and Japanese Unexamined Patent Publication No. 2001-218015 can be used, for example. More specifically, graininess is reduced in such a manner that an intermediate frequency component is reduced more as the degree G of graininess becomes larger. The processing for reducing graininess may be carried out only on the face region P0f, instead of the entire image P0.

As has been described above, according to the third graininess reduction processing in the embodiment of the present invention, the reconstruction unit 36 reconstructs the face region P0f detected in the image P0 by the face detection unit 31 by fitting to the face region P0f the mathematical model M′ generated according to the method of AAM using the sample images representing human faces without a grain component, and generates the reconstructed image P1f from which the grain component has been removed. The difference values Psub are calculated between the pixel values corresponding to each other in the reconstructed image P1f and the face region P0f, and the graininess degree acquisition unit 37 obtains the degree G of graininess in the face region P0f based on the difference values Psub. The graininess reduction unit 38 then reduces graininess of the image P0 based on the degree G of graininess. Therefore, graininess can be reduced appropriately according to the degree of graininess of the image P0.

In the embodiment described above, the mathematical model M is unique. However, a plurality of mathematical models Mi (i=1, 2, . . . ) may be generated for respective properties such as race, age, and gender, for example. FIG. 15 is a block diagram showing details of the first graininess reduction processing in this case. The plurality of mathematical models Mi can also be applied to the second and third graininess reduction processing in the same manner. As shown in FIG. 15, a property acquisition unit 39 and a model selection unit 40 are added, which is different from the embodiment shown in FIG. 4. The property acquisition unit 39 obtains property information AK of a subject in the image P0. The model selection unit 40 selects a mathematical model MK generated only from sample images representing subjects having a property represented by the property information AK.

The mathematical models Mi have been generated based on the same method (see FIG. 5), only from sample images representing subjects of the same race, age, and gender, for example. The mathematical models Mi are stored by being related to property information Ai representing each of the properties that is common among the samples used for the model generation.

The property acquisition unit 39 may obtain the property information AK by judging the property of the subject through execution of known recognition processing (such as processing described in Japanese Unexamined Patent Publication No. 11(1999)-175724) on the image P0. Alternatively, the property of the subject may be recorded at the time of photography as accompanying information of the image P0 in a header or the like so that the recorded information can be obtained. The property of the subject may be inferred from accompanying information. In the case where GPS information representing a photography location is available, the country or region corresponding to the GPS information can be identified, for example. Therefore, the race of the subject can be inferred to some degree. By paying attention to this fact, a reference table relating GPS information to information on race may be generated in advance. By inputting the image P0 obtained by a digital camera that obtains the GPS information at the time of photography and records the GPS information in a header of the image P0 (such as a digital camera described in Japanese Unexamined Patent Publication No. 2004-153428), the GPS information recorded in the header of the image data P0 is obtained. The information on race related to the GPS information may be inferred as the race of the subject when the reference table is referred to according to the GPS information.

The model selection unit 40 obtains the mathematical model MK related to the property information AK obtained by the property acquisition unit 39, and the parameter acquisition unit 32 fits the mathematical model MK to the face region P0f in the image P0.

As has been described above, in the case where the mathematical models Mi corresponding to the properties have been prepared, if the model selection unit 40 selects the mathematical model MK related to the property information AK obtained by the property acquisition unit 39 and if the parameter acquisition unit 32 fits the selected mathematical model MK to the face region P0f, the mathematical model MK does not have eigenvectors contributing to variations in face shape and luminance caused by difference in the property represented by the property information AK. Therefore, the face region P0f can be represented only by eigenvectors representing factors determining the face shape and luminance other than the factor representing the property. Consequently, processing accuracy improves.

From the viewpoint of processing accuracy improvement, it is preferable for the mathematical models Mi for the respective properties to be specified further so that a mathematical model for each individual as a subject can be generated. In this case, information for identifying the individual needs to be related to the image P0.

In the embodiment described above, the mathematical models are installed in the digital photograph printer in advance. However, from a viewpoint of processing accuracy improvement, it is preferable for mathematical models for different human races to be prepared so that which of the mathematical models is to be installed can be changed according to a country or a region to which the digital photograph printer is going to be shipped.

The function for generating the mathematical model may be installed in the digital photograph printer. More specifically, a program for causing the arithmetic and control unit 50 to execute the processing described by the flow chart in FIG. 5 is installed therein. In addition, a default mathematical model may be installed at the time of shipment of the printer. In this case, the mathematical model may be customized based on images input to the digital photograph printer. Alternatively, a new model different from the default model may be generated. This is especially effective in the case where the model for each individual is generated.

In the first graininess reduction processing in the embodiment described above, the parameter C0 is changed to the parameter C1, and the image P1′ in which graininess has been reduced is obtained by reducing graininess in the face region P0f according to the parameter C1 having been changed. However, the image P0 may be displayed on the display 55 so that the operator can change the parameter C0 while viewing how graininess changes in the image P0 with use of the keyboard 56 or the mouse 57. In this case, the parameter C0 causing the image P0 to become desirable is used as the parameter C1. In this manner, the image P1′ from which graininess has been removed can be obtained.

In the embodiment described above, the individual face image is represented by the weight coefficients bi and λi for the face shape and the pixel values of RGB colors. However, the face shape is correlated to variation in the pixel values of RGB colors. Therefore, a new appearance parameter c can be obtained for controlling both the face shape and the pixel values of RGB colors as shown by Equations (8) and (9) below, through further execution of principal component analysis on a vector (b1, b2, . . . , bi, . . . , λ1, λ2, . . . , λi, . . . ) combining the weight coefficients bi and λi:
S=S₀+Q_{S}c (8)
A=A₀+Q_{A}c (9)

A difference from the mean face shape can be represented by the appearance parameter c and a vector QS, and a difference from the mean pixel values can be represented by the appearance parameter c and a vector QA.

In the case where this model is used, the parameter acquisition unit 32 finds the face pixel values in the mean face shape based on Equation (9) above while changing a value of the appearance parameter c. Thereafter, the face image is reconstructed by conversion from the mean face shape according to Equation (8) above, and the value of the appearance parameter c causing a difference between the reconstructed face image and the face region P0f to be minimal is found.

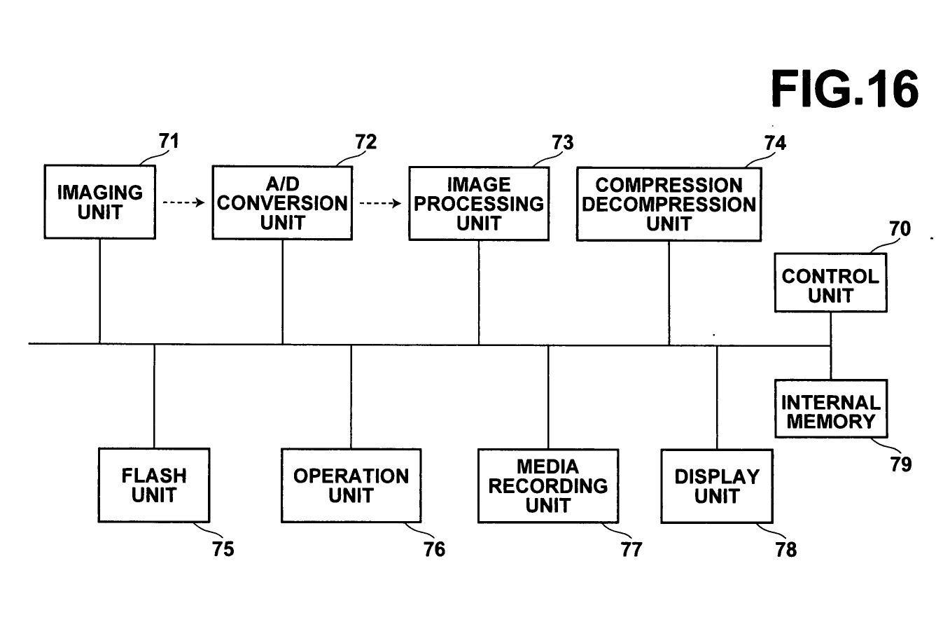

Another embodiment of the present invention can be installation of the first to third graininess reduction processing in a digital camera. In other words, the graininess reduction processing is installed as an image processing function of the digital camera. FIG. 16 shows the configuration of such a digital camera. As shown in FIG. 16, the digital camera has an imaging unit 71, an A/D conversion unit 72, an image processing unit 73, a compression/decompression unit 74, a flash unit 75, an operation unit 76, a media recording unit 77, a display unit 78, a control unit 70, and an internal memory 79. The imaging unit 71 comprises a lens, an iris, a shutter, a CCD, and the like, and photographs a subject. The A/D conversion unit 72 obtains digital image data P0 by digitizing an analog signal represented by charges stored in the CCD of the imaging unit 71. The image processing unit 73 carries out various kinds of image processing on image data such as the image data P0. The compression/decompression unit 74 carries out compression processing on image data to be stored in a memory card, and carries out decompression processing on image data read from a memory card in a compressed form. The flash unit 75 comprises a flash and the like, and carries out flash emission. The operation unit 76 comprises various kinds of operation buttons, and is used for setting a photography condition, an image processing condition, and the like. The media recording unit 77 is used as an interface with a memory card in which image data are stored. The display unit 78 comprises a liquid crystal display (hereinafter referred to as the LCD) and the like, and is used for displaying a through image, a photographed image, various setting menus, and the like. The control unit 70 controls processing carried out by each of the units. The internal memory 79 stores a control program, image data, and the like.

The functions of the image input means 1 in FIG. 2 are realized by the imaging unit 71 and the A/D conversion unit 72. Likewise, the functions of the image correction means 2 are realized by the image processing unit 73 while the functions of the image manipulation means 3 are realized by the image processing unit 73, the operation unit 76, and the display unit 78. The functions of the image output means 4 are realized by the media recording unit 77. All of the functions described above are realized under control of the control unit 70 with use of the internal memory 79.

Operation of the digital camera and a flow of processing therein is described next.

The imaging unit 71 causes light entering the lens from a subject to form an image on a photoelectric surface of the CCD when a photographer fully presses a shutter button. After photoelectric conversion, the imaging unit 71 outputs an analog image signal, and the A/D conversion unit 72 converts the analog image signal output from the imaging unit 71 to a digital image signal. The A/D conversion unit 72 then outputs the digital image signal as the digital image data P0. In this manner, the imaging unit and the A/D conversion unit 72 function as the image input means 1.

Thereafter, the image processing unit 73 carries out gradation correction processing, density correction processing, color correction processing, white balance adjustment processing, and sharpness processing in addition to the graininess reduction processing of the present invention, and outputs corrected image data P1. In this manner, the image processing unit 73 functions as the image correction means 2. In order to realize the graininess reduction processing, the control unit 70 starts a graininess reduction program stored in the internal memory 79, and causes the image processing unit 73 to carry out the graininess reduction processing (see FIGS. 4, 10, and 12) using the mathematical model M or M′ stored in advance in the internal memory 79, as has been described above.

The image P1 is displayed on the LCD of the display unit 78. As a manner of this display can be used display of thumbnail images as shown in FIG. 3A. While operating the operation buttons of the operation unit 76, the photographer selects and enlarges one of the images to be processed, and carries out selection from a menu for further manual image correction or manipulation. Processed image data P2 are then output. In this manner, the functions of the image manipulation means 3 are realized.

The compression/decompression unit 74 carries out compression processing on the image data P2 according to a compression format such as JPEG, and the compressed image data are written via the media recording unit 77 in a memory card inserted in the digital camera. In this manner, the functions of the image output means 4 are realized.

By installing the graininess reduction processing of the present invention as the image processing function of the digital camera, the same effect as in the case of the digital photograph printer can be obtained.

The manual correction and manipulation may be carried out on the image having been stored in the memory card. More specifically, the compression/decompression unit 74 decompresses the image data stored in the memory card, and the image after the decompression is displayed on the LCD of the display unit 78. The photographer selects desired image processing as has been described above, and the image processing unit 73 carries out the selected image processing.

Furthermore, the mathematical models for respective properties of subjects described by FIG. 15 may be installed in the digital camera. In addition, the processing for generating the mathematical model described by FIG. 5 may be installed therein. A person as a subject of photography is often fixed to some degree for each digital camera. Therefore, if a mathematical model is generated for the face of each individual as a frequent subject of photography with the digital camera, a model without variation of individual difference in face can be generated. Consequently, the graininess reduction processing can be carried out with extremely high accuracy for the face of the person.

A program of the present invention may be incorporated with image editing software for causing a personal computer or the like to execute the first to third graininess reduction processing. In this manner, a user can use the graininess reduction processing of the present invention as an option of image editing and manipulation on his/her personal computer, by installation of the software from a recording medium such as a CD-ROM to the personal computer, or by installation of the software through downloading of the software from a predetermined Web site on the Internet.

What is claimed is:

1. An image processing apparatus comprising:
parameter acquisition means for obtaining a weighting parameter for a statistical characteristic quantity representing a degree of graininess in a predetermined structure in an input image by fitting a model representing the structure to the structure in the input image, the model having been obtained by carrying out predetermined statistical processing on a plurality of images representing the predetermined structure in different degrees of graininess, and the model representing the structure by one or more statistical characteristic quantities including the statistical characteristic quantity representing the degree of graininess and by weighting parameter or parameters for weighting the statistical characteristic quantity or quantities according to an individual characteristic of the structure;
parameter changing means for changing a value of the weighting parameter obtained by the parameter acquisition means to a desired value; and
graininess reduction means for reducing graininess of the structure in the input image according to the weighting parameter having been changed.

2. The image processing apparatus according to claim 1, wherein the predetermined structure is a human face.

3. The image processing apparatus according to claim 1 further comprising detection means for detecting the structure in the input image, wherein
the parameter acquisition means obtains the weighting parameter by fitting the model to the structure having been detected.

4. The image processing apparatus according to claim 1 further comprising selection means for obtaining a property of the structure in the input image and for selecting the model corresponding to the property from a plurality of the models representing the predetermined structure for respective properties of the structure, wherein
the parameter acquisition means obtains the weighting parameter by fitting the selected model to the structure.

5. An image processing apparatus comprising:
parameter acquisition means for obtaining a weighting parameter for a statistical characteristic quantity representing a degree of graininess in a predetermined structure in an input image by fitting a model representing the structure to the structure in the input image, the model having been obtained by carrying out predetermined statistical processing on a plurality of images representing the predetermined structure in different degrees of graininess, and the model representing the structure by one or more statistical characteristic quantities including the statistical characteristic quantity representing the degree of graininess and by weighting parameter or parameters for weighting the statistical characteristic quantity or quantities according to an individual characteristic of the structure; and
graininess reduction means for reducing graininess in the input image according to a value of the weighting parameter having been obtained by the parameter acquisition means.

6. The image processing apparatus according to claim 5, wherein the predetermined structure is a human face.

7. The image processing apparatus according to claim 5 further comprising detection means for detecting the structure in the input image, wherein
the parameter acquisition means obtains the weighting parameter by fitting the model to the structure having been detected.

8. The image processing apparatus according to claim 5 further comprising selection means for obtaining a property of the structure in the input image and for selecting the model corresponding to the property from a plurality of the models representing the predetermined structure for respective properties of the structure, wherein
the parameter acquisition means obtains the weighting parameter by fitting the selected model to the structure.

9. An image processing apparatus comprising:
reconstruction means for generating a reconstructed image of a predetermined structure in an input image having a grain component by reconstructing an image representing the structure after fitting a model representing the structure to the structure in the input image, the model having been obtained by carrying out predetermined statistical processing on a plurality of images representing the predetermined structure without a grain component, and the model representing the structure by one or more statistical characteristic quantities and by weighting parameter or parameters for weighting the statistical characteristic quantity or quantities according to an individual characteristic of the structure;
graininess degree acquisition means for obtaining a degree of graininess in the structure in the input image by calculating a difference value between values of pixels corresponding to each other in the predetermined structure in the reconstructed image and in the input image; and
graininess reduction means for reducing graininess in the input image according to the degree of graininess obtained by the graininess degree acquisition means.

10. The image processing apparatus according to claim 9, wherein the predetermined structure is a human face.

11. The image processing apparatus according to claim 9 further comprising detection means for detecting the structure in the input image, wherein
the reconstruction means generates the reconstructed image by fitting the model to the structure having been detected.

12. The image processing apparatus according to claim 9 further comprising selection means for obtaining a property of the structure in the input image and for selecting the model corresponding to the property from a plurality of the models representing the predetermined structure for respective properties of the structure, wherein
the reconstruction means generates the reconstructed image by fitting the selected model to the structure.

13. An image processing method comprising the steps of:
obtaining a weighting parameter for a statistical characteristic quantity representing a degree of graininess in a predetermined structure in an input image by fitting a model representing the structure to the structure in the input image, the model having been obtained by carrying out predetermined statistical processing on a plurality of images representing the predetermined structure in different degrees of graininess, and the model representing the structure by one or more statistical characteristic quantities including the statistical characteristic quantity representing the degree of graininess and by weighting parameter or parameters for weighting the statistical characteristic quantity or quantities according to an individual characteristic of the structure; and
changing a value of the weighting parameter to a desired value; and
reducing graininess of the structure in the input image according to the weighting parameter having been changed.

14. An image processing method comprising the steps of:
obtaining a weighting parameter for a statistical characteristic quantity representing a degree of graininess in a predetermined structure in an input image by fitting a model representing the structure to the structure in the input image, the model having been obtained by carrying out predetermined statistical processing on a plurality of images representing the predetermined structure in different degrees of graininess, and the model representing the structure by one or more statistical characteristic quantities including the statistical characteristic quantity representing the degree of graininess and by weighting parameter or parameters for weighting the statistical characteristic quantity or quantities according to an individual characteristic of the structure; and
reducing graininess in the input image according to a value of the weighting parameter having been obtained.

15. An image processing method comprising the steps of:
generating a reconstructed image of a predetermined structure in an input image having a grain component by reconstructing an image representing the structure after fitting a model representing the structure to the structure in the input image, the model having been obtained by carrying out predetermined statistical processing on a plurality of images representing the predetermined structure without a grain component, and the model representing the structure by one or more statistical characteristic quantities and by weighting parameter or parameters for weighting the statistical characteristic quantity or quantities according to an individual characteristic of the structure;
obtaining a degree of graininess in the structure in the input image by calculating a difference value between values of pixels corresponding to each other in the predetermined structure in the reconstructed image and in the input image; and
reducing graininess in the input image according to the degree of graininess having been obtained.

16. An image processing program for causing a computer to function as:
parameter acquisition means for obtaining a weighting parameter for a statistical characteristic quantity representing a degree of graininess in a predetermined structure in an input image by fitting a model representing the structure to the structure in the input image, the model having been obtained by carrying out predetermined statistical processing on a plurality of images representing the predetermined structure in different degrees of graininess, and the model representing the structure by one or more statistical characteristic quantities including the statistical characteristic quantity representing the degree of graininess and by weighting parameter or parameters for weighting the statistical characteristic quantity or quantities according to an individual characteristic of the structure;
parameter changing means for changing a value of the weighting parameter obtained by the parameter acquisition means to a desired value; and
graininess reduction means for reducing graininess of the structure in the input image according to the weighting parameter having been changed.

17. An image processing program for causing a computer to function as:
parameter acquisition means for obtaining a weighting parameter for a statistical characteristic quantity representing a degree of graininess in a predetermined structure in an input image by fitting a model representing the structure to the structure in the input image, the model having been obtained by carrying out predetermined statistical processing on a plurality of images representing the predetermined structure in different degrees of graininess, and the model representing the structure by one or more statistical characteristic quantities including the statistical characteristic quantity representing the degree of graininess and by weighting parameter or parameters for weighting the statistical characteristic quantity or quantities according to an individual characteristic of the structure; and
graininess reduction means for reducing graininess in the input image according to a value of the weighting parameter having been obtained by the parameter acquisition means.

18. An image processing program for causing a computer to function as:
reconstruction means for generating a reconstructed image of a predetermined structure in an input image having a grain component by reconstructing an image representing the structure after fitting a model representing the structure to the structure in the input image, the model having been obtained by carrying out predetermined statistical processing on a plurality of images representing the predetermined structure without a grain component, and the model representing the structure by one or more statistical characteristic quantities and by weighting parameter or parameters for weighting the statistical characteristic quantity or quantities according to an individual characteristic of the structure;
graininess degree acquisition means for obtaining a degree of graininess in the structure in the input image by calculating a difference value between values of pixels corresponding to each other in the predetermined structure in the reconstructed image and in the input image; and
graininess reduction means for reducing graininess in the input image according to the degree of graininess obtained by the graininess degree acquisition means.
